(19) United States
(12) Patent Application Publication
(10) Pub. No.: US 2025/0326227 A1
(43) Pub. Date: Oct. 23, 2025

(54) LIQUID STORAGE BOTTLE AND LIQUID REPLENISHMENT SYSTEM

(71) Applicant: CANON KABUSHIKI KAISHA, Tokyo (JP)

(72) Inventors: ATSUSHI OMURA, Kanagawa (JP); AKANE HISANAGA, Tokyo (JP)

(21) Appl. No.: 19/183,594

(22) Filed: Apr. 18, 2025

(30) Foreign Application Priority Data
Apr. 23, 2024 (JP) 2024-069695

(51) Int. Cl. B41J 2/175

(52) U.S. Cl. CPC B41J 2/175

(57) ABSTRACT

A liquid storage bottle including a groove or a rib that can hold, by capillary action, ink adhering to a nozzle tip part of the liquid storage bottle after the ink is supplied from the liquid storage bottle to a liquid tank, and a liquid replenishment system.

### BACKGROUND

### Technical Field

The present disclosure relates to a liquid storage bottle storing liquid such as ink, and to a liquid replenishment system including a liquid tank to which the liquid storage bottle is connected.

### Description of the Related Art

Some liquid tanks used in a liquid ejection apparatus such as an inkjet recording apparatus can be replenished with liquid from a liquid storage bottle separately prepared. In the liquid ejection apparatus, the liquid storage bottle is attached to the liquid tank when the ink is supplied to the liquid tank. When the liquid storage bottle is attached to the liquid tank, the inside of the liquid storage bottle and the inside of the liquid tank communicate with each other through a flow path in a nozzle provided in the liquid storage bottle. When a side wall of an ink storage portion of the liquid storage bottle is pushed in a state where the liquid storage bottle is attached to the liquid tank, liquid for printing such as ink can be supplied from the liquid storage bottle to the liquid tank.

Japanese Patent Application Laid-Open No. 2020-189454 discusses what is called a chicken feed system with regard to supplying ink from the liquid storage bottle to the liquid tank. The liquid storage bottle includes two flow paths through which liquid or gas flows in the nozzle, and can perform gas-liquid exchange by causing air to flow from an opening of one of the flow paths and causing the ink to flow from an opening of the other of the flow paths. When the ink flows into the liquid tank, a liquid level of the ink rises and reaches the opening of the flow path through which the air flows in the nozzle of the liquid storage bottle, thereby flowing of the air is blocked. As a result, flowing of the ink from the liquid storage bottle to the liquid tank is stopped.

When the liquid storage bottle is attached to the liquid tank in the above-described chicken feed system, the ink may adhere to a periphery of an opening at a nozzle tip part through which the liquid in the liquid storage bottle is extracted. In Japanese Patent Application Laid-Open No. 2020-189454, supply of the ink from the liquid storage bottle to the liquid tank is stopped when the liquid level of the ink inside the liquid tank comes into contact with the opening at the nozzle tip part of the liquid storage bottle.

Therefore, when the liquid storage bottle is detached from the liquid tank after supply of the ink from the liquid storage bottle to the liquid tank is stopped, it is highly likely that the ink adheres to the periphery of the opening at the nozzle tip part of the liquid storage bottle. There is a concern that the ink adhering to the periphery of the opening may drip and soil user's hands or a periphery of the liquid ejection apparatus.

### SUMMARY

The present disclosure has been made in view of the above disadvantages and is directed to reducing dripping of the ink adhering to the periphery of the opening at the nozzle tip part of the liquid storage bottle and dropping of the ink to a side surface of the liquid storage bottle after the ink is supplied to the liquid tank.

According to an aspect of the present disclosure, a liquid storage bottle for replenishing liquid to a recording apparatus including a liquid tank, the liquid tank including a storage portion configured to store the liquid to be supplied to a recording head configured to eject the ink, and a liquid injection portion configured to receive supply of the liquid, includes a bottle main body configured to store the liquid, and a liquid supply portion including a base end part having an opening communicating with the bottle main body and a tip part having an opening communicating with the liquid tank, and including a liquid flow path for supplying the liquid from the bottle main body to the liquid tank, wherein a holding portion configured to hold the liquid by capillary action is provided on an inner peripheral surface of the opening at the tip part.

Further features of the present disclosure will become apparent from the following description of exemplary embodiments with reference to the attached drawings.

### BRIEF DESCRIPTION OF THE DRAWINGS

FIG. 1 is a perspective view of a recording apparatus according to an exemplary embodiment.

FIG. 2 is a cross-sectional view illustrating main units of the recording apparatus in FIG. 1.

FIG. 3 is a perspective view illustrating a state where liquid is replenished in a liquid replenishment system according to the exemplary embodiments.

FIG. 4 is a configuration diagram of parts of a liquid storage bottle according to a first exemplary embodiment.

FIGS. 5A and 5B are cross-sectional views of a nozzle main body according to the first exemplary embodiment.

FIGS. 6A and 6B are cross-sectional views illustrating a state where liquid is replenished in a liquid replenishment system according to the first exemplary embodiment.

FIGS. 7A to 7L are plan views and cross-sectional views of a liquid holding portion according to the first exemplary embodiment.

FIGS. 8A to 8C are system diagrams illustrating defining of a connection posture by engagement according to a second exemplary embodiment.

FIGS. 9A and 9B are plan views of a liquid holding portion according to a third exemplary embodiment.

FIGS. 10A to 10C are diagrams illustrating a nozzle main body according to a fourth exemplary embodiment.

FIGS. 11A to 11C are diagrams illustrating a nozzle main body according to a fifth exemplary embodiment.

FIG. 12 is a cross-sectional view of the liquid holding portion and a forming step diagram according to the first exemplary embodiment.

FIGS. 13A to 13D are diagrams illustrating a nozzle main body according to a sixth exemplary embodiment.

FIGS. 14A and 14B are diagrams illustrating a nozzle main body according to a seventh exemplary embodiment.

### DESCRIPTION OF THE EMBODIMENTS

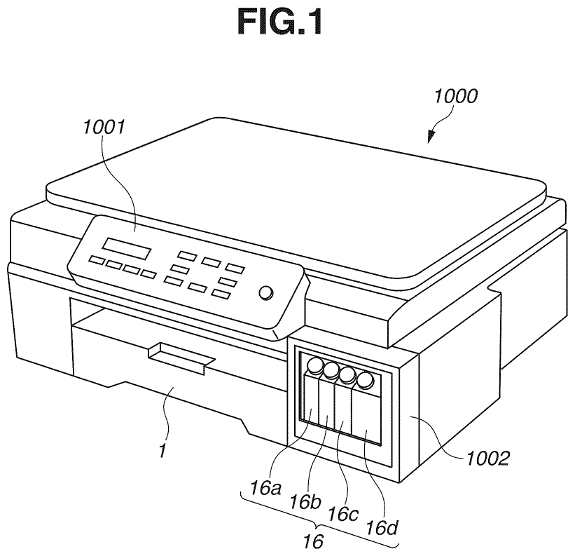

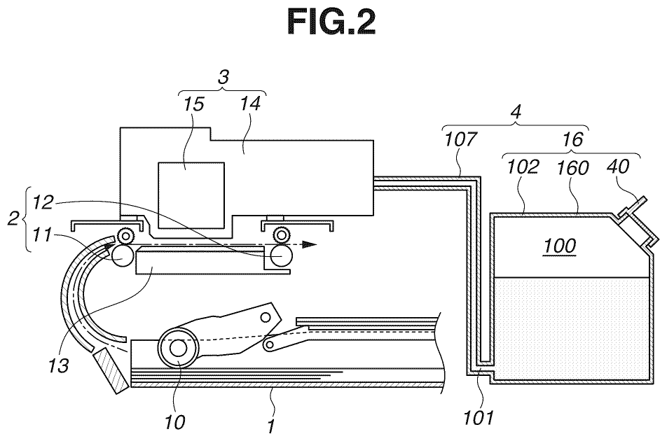

Some exemplary embodiments of the present disclosure are described below with reference to the drawings. FIG. 1 is a perspective view of an inkjet recording apparatus according to an exemplary embodiment of the present disclosure. FIG. 2 is a cross-sectional view schematically illustrating main units of the inkjet recording apparatus according to the present exemplary embodiment. An inkjet recording apparatus 1000 (hereinafter, also referred to as “recording apparatus”) includes a first feeding unit 1, a second feeding unit 2, a recording unit 3, and a liquid supplying unit 4.

The first feeding unit 1 includes a feeding roller 10 that separates a recording medium one by one from a bundle of loaded recording media, and supplies the recording medium to the second feeding unit 2. The second feeding unit 2 includes a conveyance roller 11 and a sheet discharge roller 12 that are provided on a downstream side of the first feeding unit 1 in a conveyance direction of the recording medium and convey the recording medium fed from the feeding roller 10. A platen 13 that supports, from below, the recording medium conveyed by the second feeding unit 2 is provided between the conveyance roller 11 and the sheet discharge roller 12. The recording unit 3 includes a carriage 14 that is provided at a position facing the platen 13 and reciprocates in a direction orthogonal to the conveyance direction of the recording medium, and a recording head 15 that is mounted on the carriage 14 and includes a plurality of ejection port arrays each including a plurality of ejection ports.

When energy generation elements provided corresponding to the ejection ports are driven based on recording data, the recording head 15 ejects ink of different colors from the ejection port arrays, thereby recording a color image on the recording medium supported by the platen 13. The liquid supplying unit 4 includes a liquid tank 16 that is a translucent or transparent container, and a flexible supply tube 107 connecting the liquid tank 16 and the recording head 15. In the present exemplary embodiment, ink of four colors (cyan, magenta, yellow, and black) is used as the liquid. As the liquid tank 16, four liquid tanks 16a to 16d storing the ink of respective colors are provided.

The liquid tank 16 includes a tank main body 160 that includes a storage chamber 100 storing the liquid, and a tank cap 40 that is attachable to the tank main body 160 to seal the storage chamber 100. A supply port 101 connected to the supply tube 107 is provided at a lower part of the tank main body 160, and an atmosphere communication port 102 causing the storage chamber 100 to communicate with atmosphere is provided on an upper surface of the tank main body 160. When the liquid is ejected from the recording head 15, negative pressure inside the recording head 15 is increased, and accordingly, the liquid stored in the storage chamber 100 in the liquid tank 16 is supplied from the supply port 101 to the recording head 15 through the supply tube 107. At this time, the same amount of air as the amount of liquid supplied to the recording head 15 flows into the storage chamber 100 in the liquid tank 16 through the atmosphere communication port 102.

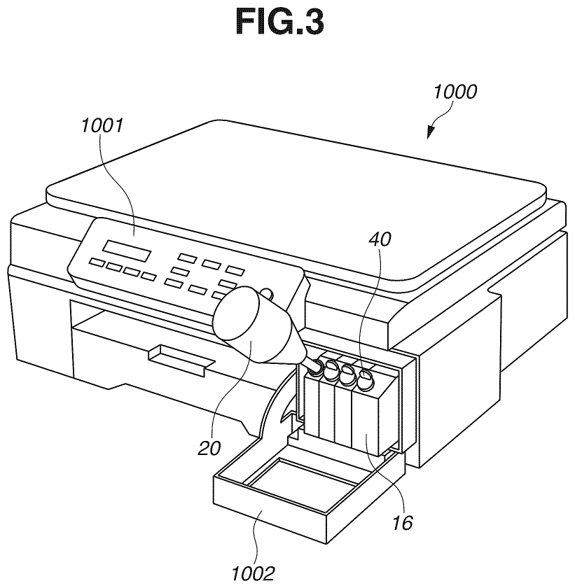

FIG. 3 is a perspective view of a liquid replenishment system illustrating a state where the liquid is replenished in the recording apparatus 1000 illustrated in FIG. 1. When a remaining amount detection unit (not illustrated) provided in the liquid tank 16 detects that a remaining amount of liquid in the storage chamber 100 is equal to or less than a predetermined amount, a display for prompting a user to replenish the liquid tank 16 with the liquid is performed on a display unit 1001 of the recording apparatus 1000. The user opens a tank cover 1002 provided on a front surface of the recording apparatus 1000 by tilting the tank cover 1002 forward and detaches the tank cap 40 attached to the liquid tank 16 to be replenished with the liquid to expose a liquid injection portion 18. The liquid tank 16 includes an inclined surface that is inclined relative to a horizontal direction and a vertical direction in a state where the recording apparatus 1000 is installed in a normal use state, and the liquid injection portion 18 is provided on the inclined surface. The user uses a liquid storage bottle 20 in which the liquid to be replenished is stored to replenish the liquid tank 16 with the liquid through the exposed liquid injection portion 18.

Note that in such a liquid replenishment system, a plurality of types (four types in the present exemplary embodiment) of liquid storage bottles 20 are prepared in advance in corresponding to the number of colors of the liquid (ink) to be used. On each of the liquid storage bottles 20, color information on the liquid (ink) stored therein is displayed. The user selects the liquid storage bottle 20 storing the liquid to be replenished, from among the plurality of prepared liquid storage bottles 20, based on displayed contents of the display unit 1001 and color information similarly displayed on the liquid tank 16.

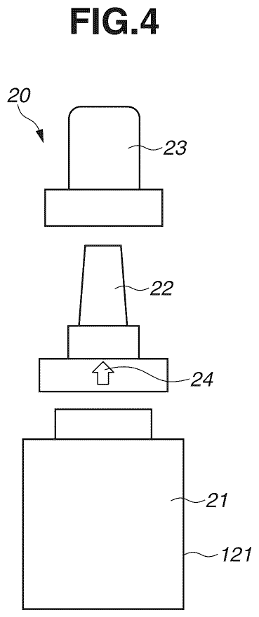

FIG. 4 is a configuration diagram of parts of the liquid storage bottle 20 that is a liquid container for replenishing the liquid to the liquid tank 16. The liquid storage bottle 20 includes a bottle main body 21 that is a main body portion storing the liquid, a nozzle main body 22 connected to the bottle main body 21, and a bottle cap 23 attached to the nozzle main body 22. The nozzle main body 22 has a function as an outlet when the liquid stored in the bottle main body 21 is supplied to the outside.

The bottle cap 23 is attached to the nozzle main body 22 to shield the inside of the liquid storage bottle 20 (more specifically, bottle) from the outside. The nozzle main body 22 is attachable to and detachable from the bottle main body 21 and can be connected thereto by a screw connection. Alternatively, the nozzle main body 22 may be configured integrally with the bottle main body 21. There are a method of sealing by interposing a flexible part between them, and a method of using resin parts for both the bottle main body 21 and the nozzle main body 22 and welding the parts. The bottle cap 23 is a single part and has a substantially columnar shape. The bottle cap 23 is attachable to and detachable from the nozzle main body 22. The bottle cap 23 is attachable to and detachable from the bottle main body 21 via the nozzle main body 22.

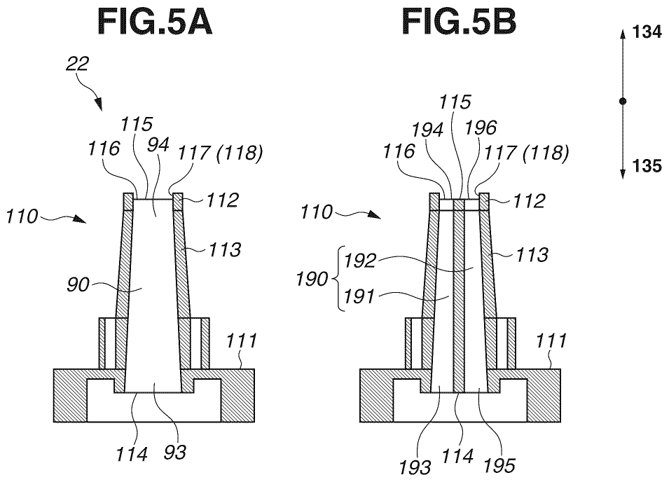

FIG. 5A and FIG. 5B are cross-sectional views illustrating two forms of the nozzle main body 22. FIG. 5A illustrates the form including one liquid flow path 90 that has an opening 93 at a base end part of the nozzle main body 22 and an opening 94 at a tip part of the nozzle main body 22. FIG. 5B illustrates the form including a first flow path 191 and a second flow path 192 that have an opening 193 and an opening 195, respectively, at the base end part of the nozzle main body 22 and a first opening 194 and a second opening 196, respectively, at the tip part thereof.

As illustrated in FIG. 5A, a nozzle 110 protrudes from an outer surface of a bottom wall 111 of the nozzle main body 22 in a first direction 134. In other words, in a state where the nozzle main body 22 is attached to the bottle main body 21, the nozzle 110 protrudes from the bottle main body 21 through the nozzle main body 22 in the first direction 134. The nozzle 110 may protrude from the bottom wall 111 in the first direction 134 and may also protrude from the bottom wall 111 in a second direction 135. In this case, the nozzle 110 is provided so as to penetrate through the bottom wall 111. The nozzle 110 has a substantially columnar shape. The nozzle 110 has an outer peripheral surface 112 of a circumferential surface shape. The outer peripheral surface 112 is inclined in a conical shape such that a diameter of an outer peripheral circle decreases from the bottom wall 111 in the first direction 134.

Alternatively, the nozzle 110 may also be configured such that the outer peripheral surface 112 extends in the vertical direction from the bottom wall 111 to the tip with the same diameter of the outer peripheral circle. Further, the shape thereof may be a shape other than the columnar shape, for example, a rectangular prism shape. The nozzle 110 includes the liquid flow path 90 through which the ink or gas passes. The liquid flow path 90 penetrates through the nozzle main body 22 in the first direction 134. While the liquid flow path 90 extends in the first direction 134, this is not restrictive, and the liquid flow path 90 may be curved. A cross-sectional shape of the liquid flow path 90 may be a circular shape or a shape other than the circular shape. In the state where the nozzle main body 22 is attached to the bottle main body 21, one end of the liquid flow path 90 communicates with the bottle main body 21 through the opening 93. The other end of the liquid flow path 90 communicates with the outside of the nozzle main body 22 through the opening 94. The liquid flow path 90 has these openings as both ends. The opening 93 has a circular shape. Alternatively, the opening 93 may have a shape other than the circular shape. The opening 93 may be formed at the base end part of the nozzle 110, and is not limited to a base end surface 114. The opening 94 is formed in a tip surface 115 constituting an end part of the nozzle 110 in the first direction 134. The opening 94 has a circular shape. Alternatively, the opening 94 may have a shape other than the circular shape.

As illustrated in FIG. 5B, the nozzle 110 may include two flow paths that are the first flow path 191 and the second flow path 192 as a flow path 190. The first flow path 191 and the second flow path 192 may have the same length or different lengths in a flowing direction of the ink. Cross-sectional shapes and cross-sectional areas of the first flow path 191 and the second flow path 192 may be the same or different. Furthermore, two or more flow paths 190 may be provided. The length and shape of each of the flow paths 190 may be the same or different. In a case where the nozzle 110 includes the two flow paths 190, the openings 193 and 195 formed at the base end part are provided on the same plane. However, these may be formed on different planes. The first opening 194 and the second opening 196 are formed in the tip surface 115 constituting the end part of the nozzle 110 in the first direction 134. The first opening 194 and the second opening 196 may be formed at the tip part of the nozzle 110, and are not limited to the tip surface 115.

The first opening 194 and the second opening 196 each have a circular shape. Alternatively, the first opening 194 and the second opening 196 each may have a shape other than the circular shape.

A tip part of the nozzle 110 is, for example, a part that includes the tip surface 115 and the outer peripheral surface 112 of the nozzle 110. The nozzle 110 includes a recessed part on the outer peripheral surface 112. The recessed part is sectioned by the tip surface 115 and an inner peripheral surface 118 (one of side surfaces) of an annular rib 117 that protrudes from a peripheral edge part of the tip surface 115 in the first direction 134. In other words, the tip surface 115 is recessed from the tip of the nozzle 110 (tip of the annular rib 117). The inner peripheral surface 118 extends toward the outside of the peripheral edge part of the tip surface 115 in the first direction 134 from the tip surface 115. In other words, the inner peripheral surface 118 extends in the first direction 134 while being inclined in a direction in which the recessed part is increased in diameter. Alternatively, the inner peripheral surface 118 may extend in the first direction 134 without being inclined. Alternatively, the nozzle 110 may not include the recessed part. In other words, the tip part of the nozzle 110 may not be recessed.

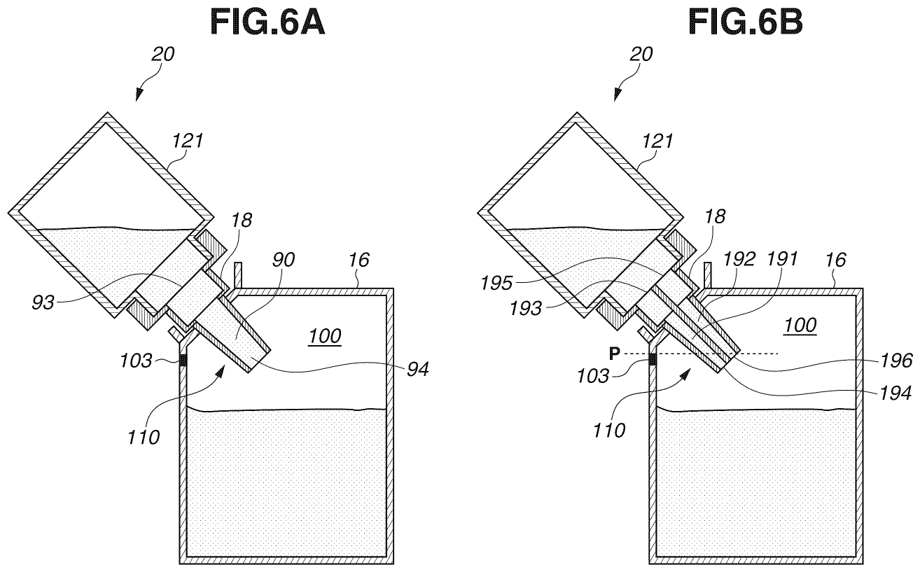

FIG. 6A and FIG. 6B each illustrate a state where the ink is replenished from the liquid storage bottle 20 to the liquid tank 16. FIG. 6A illustrates ink replenishment by the nozzle main body 22 described with reference to FIG. 5A, and FIG. 6B illustrates ink replenishment by the nozzle main body 22 described with reference to FIG. 5B. As illustrated in FIG. 6A and FIG. 6B, when the nozzle 110 of the liquid storage bottle 20 is inserted into the liquid injection portion 18 of the liquid tank 16, the liquid storage bottle 20 is connected to the liquid tank 16. Hereinafter, a posture of the liquid storage bottle 20 when the liquid storage bottle 20 is connected to the liquid tank 16 is also referred to as a connection posture. When the nozzle 110 of the liquid storage bottle 20 is inserted into the liquid injection portion 18 of the liquid tank 16, the posture of the liquid storage bottle 20 can be adjusted such that a mark 24 of the nozzle main body 22 is directed vertically upward. This makes it possible to define relative positions of the openings 94, 194, and 196 when the openings 94, 194, and 196 are positioned in the storage chamber 100. In a case where there are two openings as illustrated in FIG. 6B, when the first opening 194 and the second opening 196 are positioned in the storage chamber 100, a state where one of the first opening 194 and the second opening 196 is positioned vertically above the other can be achieved.

In the present exemplary embodiment, in the connection posture, the second opening 196 is positioned vertically above the first opening 194. When the liquid storage bottle 20 is connected to the liquid tank 16 and the opening 94, the first opening 194, and the second opening 196 are positioned in the storage chamber 100 of the liquid tank 16, the bottle main body 21 and the storage chamber 100 communicate with each other through the liquid flow paths 90, 191, and 192. In the connection posture illustrated in FIG. 6A, for example, when the user pushes in a side wall 121 of the bottle main body 21, the ink stored in the bottle main body 21 flows into the liquid flow path 90 through the opening 93. As the side wall 121 of the bottle main body 21 returns to its original shape by a reaction force, air flows into the bottle main body 21 through the opening 94. Here, a volume of ink flowing from the bottle main body 21 into the storage chamber 100 and a volume of air flowing from the storage chamber 100 into the bottle main body 21 are substantially equal to each other. In this way, gas-liquid exchange in the liquid storage bottle 20 is performed by deformation of the bottle main body 21. As a result, the ink is supplied from the liquid storage bottle 20 to the liquid tank 16.

In the connection posture illustrated in FIG. 6B, the ink is supplied from the liquid storage bottle 20 to the liquid tank 16 by what is called a chicken feed system. When the liquid storage bottle 20 is connected to the liquid tank 16 and the first opening 194 and the second opening 196 are positioned in the storage chamber 100 of the liquid tank 16, the bottle main body 21 and the storage chamber 100 communicate with each other through the first flow path 191 and the second flow path 192. Accordingly, the ink stored in the bottle main body 21 flows into the first flow path 191 through the opening 193, and flows into the storage chamber 100 through the first opening 194. On the other hand, during flowing of the ink, air in the storage chamber 100 maintained at atmospheric pressure by the atmosphere communication port 102 flows into the bottle main body 21 through the second flow path 192. Here, a volume of ink flowing from the bottle main body 21 into the storage chamber 100 and a volume of air flowing from the storage chamber 100 into the bottle main body 21 are substantially equal to each other. In this way, the gas-liquid exchange is performed.

When the ink flows into the storage chamber 100 and a liquid level of the ink in the storage chamber 100 rises and reaches the same height as the second opening 196, i.e., reaches the same height as a mark 103, flowing of the air between the storage chamber 100 and the bottle main body 21 through the second flow path 192 is blocked. Thus, flowing of the ink from the bottle main body 21 to the storage chamber 100 is stopped.

As described above, when supply of the ink from the liquid storage bottle 20 to the liquid tank 16 is naturally stopped, the tip of the nozzle 110 comes into contact with the ink. Further, when the nozzle 110 is taken out from the liquid tank 16, the ink adhering to a periphery of the liquid injection portion 18 may come into contact with the tip part of the nozzle 110. As a result, there is a concern that a hand or the periphery of the user may be stained due to dripping of the ink from the tip of a nozzle part and dropping of the ink to a side surface of the nozzle 110 of the liquid storage bottle 20. In each exemplary embodiment described below, an effect of reducing the above-described concern is expected.

In a first exemplary embodiment, a state is described where a groove is provided on an inner peripheral surface of the liquid flow path at the tip part of the nozzle main body 22 to retain the liquid by capillary action.

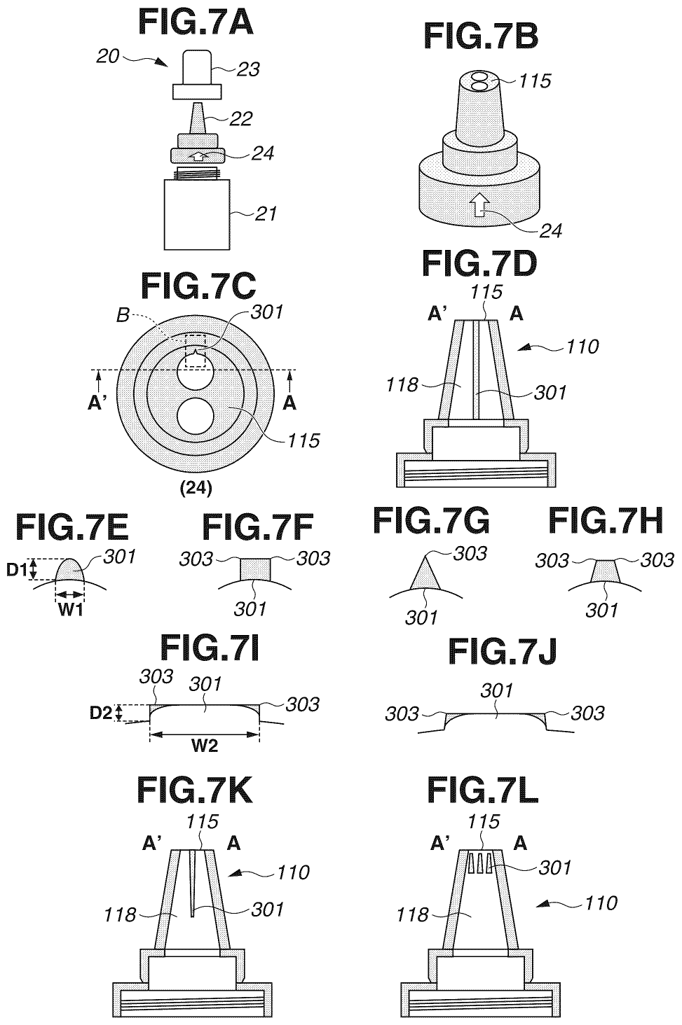

FIG. 7A is an overall view of the liquid storage bottle 20 suitable for an exemplary embodiment of the present disclosure, illustrated for each part. The mark 24 is provided on the nozzle main body 22. By providing a mark for defining the connection posture such as the mark 24, the flow path provided with the groove is guided to be on a vertically lower side when the user injects the ink into the liquid tank of the recording apparatus. The bottle cap 23 is attachable to and detachable from the nozzle main body 22, and can prevent the ink held inside the bottle from leaking at times other than injection. FIG. 7B is a perspective view of the nozzle main body 22. FIG. 7C is a diagram of the nozzle main body 22 as viewed from above. The nozzle main body 22 has the tip surface 115. FIG. 7D is a cross-sectional view taken along line A-A′ in FIG. 7C. In the present exemplary embodiment, a groove 301 having a fixed width is provided on an inner peripheral surface of one flow path, and the groove 301 is a part of the opening at a nozzle tip part. FIGS. 7E to 7J are enlarged views of a region B illustrated in FIG. 7C.

Action of the groove 301 according to the present exemplary embodiment is described with reference to FIGS. 7E to 7J. After the ink flows through the flow path provided with the groove 301, meniscus is formed inside the groove 301 by capillary action, and the ink is held therein. In other words, the groove 301 function as a holding portion that holds the ink on the inner peripheral surface of the flow path. The capillary action largely depends on surface tension among physical properties of the ink, and is determined by a contact angle with the flow path and a shape of the groove. The ink for inkjet recording is generally designed to have the appropriate physical properties in consideration of ink ejection performance and image formation on a recording medium. For example, the surface tension of the ink is often designed to be 25 to 45 mN/m, and the contact angle is often designed to be 10 to 70 degrees. In the present exemplary embodiment, ink having the surface tension of 35 mN/m is used, and the contact angle with an inner wall of the flow path in the nozzle 110 is about 30 degrees.

A cross-sectional shape of the groove 301 is a fine groove shape that can generate the capillary action, and FIGS. 7E to 7J illustrate examples of the cross-sectional shape. By the capillary action of the ink held in the groove 301, an effect of drawing the ink adhering to the tip surface 115 of the nozzle 110 into the holding portion in a direction of the inside of the bottle can be expected. The groove 301 desirably has a corner part 303 as in the case of a rectangle illustrated in FIG. 7F, a triangle illustrated in FIG. 7G, a trapezoidal shape illustrated in FIG. 7H, or the like. This makes it possible to enhance an ink holding force. Further, an opening width of the groove 301 may be large as illustrated in FIG. 7I and FIG. 7J as long as the groove 301 has the corner part 303 that can draw the ink by the capillary action.

For example, in a case where the groove 301 is formed by a forming die, the groove 301 having a narrow width as illustrated in FIG. 7E to FIG. 7H is formed to have a width W1 of about 0.1 mm to 2 mm. The groove 301 as illustrated in FIG. 7I and FIG. 7J is formed to have a width W2 of about 2 mm or more to 5 mm. Further, a depth D1 is formed to be about 0.05 mm to 5 mm. A method of forming the groove 301 is not limited to a method using the forming die, and the groove 301 may be formed by other methods. The widths W1 and W2 and the depth D1 of the groove 301 are not limited thereto.

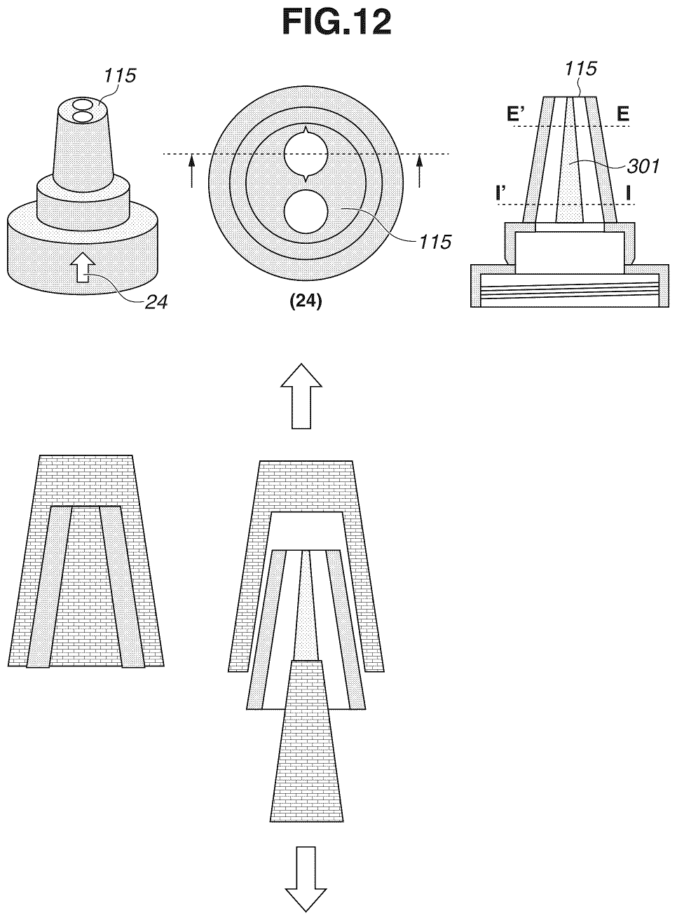

Further, as illustrated in FIG. 7K, the groove may extend from the nozzle tip part to a position partway between the nozzle tip part and the base end part. A total amount of ink that can be held is reduced, and the capillary action disappears at the position where the groove disappears, but the effect of drawing the ink adhering to the nozzle tip part into the nozzle can be expected. In addition, the width of the groove need not necessarily be constant. For example, during die-cutting formation as illustrated in FIG. 12, the width that gradually increases facilitates die-cutting. In the case as illustrated in FIG. 12, a cross-section taken along line E-E′ is as illustrated in FIG. 7E, and a cross-section taken along line I-I′ is as illustrated in FIG. 7I. Both parts have the capillary action as described above, and can hold the ink.

Further, as illustrated in FIG. 7L, a plurality of grooves may be provided as a holding portion on the inner peripheral surface only near the tip part. This makes it possible to generate the capillary action for holding the ink inside the flow path at the nozzle tip part so as to prevent the ink from dripping. In this case, the holding portion need not necessarily be formed of only the plurality of grooves, and may be formed of a plurality of ribs, or a combination thereof.

A second exemplary embodiment describes defining of the connection posture of the liquid storage bottle 20 in the liquid replenishment system in a state where the liquid is replenished in the recording apparatus 1000 illustrated in FIG. 1.

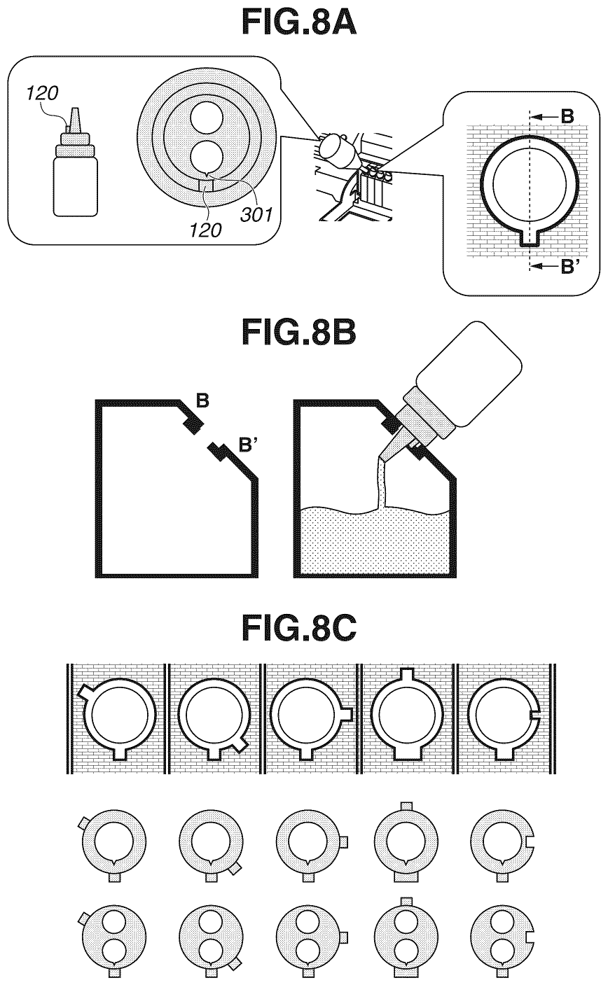

As illustrated in FIGS. 8A to 8C, in the present exemplary embodiment, the connection posture is defined by an engagement combination of an opening shape of the liquid injection portion 18 provided on the liquid tank 16 of the recording apparatus 1000 and a shape of the nozzle 110 of the liquid storage bottle 20. Further, as in the first exemplary embodiment, one groove 301 having the fixed width is provided on the inner peripheral surface of one flow path, and the groove 301 is a part of the opening at the nozzle tip part.

As illustrated in FIG. 8A, the shape of the injection port of the liquid tank and the outer shape of the nozzle part of the bottle are configured so as to uniquely engage with each other when the user injects the ink, and the inner wall portion provided with the groove is positioned on a vertically lower side. As a result, the groove 301 is surely positioned on the vertically lower part during injection of the ink, and an effect of drawing the ink adhering to the tip surface 115 of the nozzle 110 in the direction of the inside of the bottle by the capillary action of meniscus formed in the groove 301 can be expected. FIG. 8B is a cross-sectional view taken along line B-B′in FIG. 8A and illustrates the liquid tank and the bottle when the user injects the ink. Further, in the present exemplary embodiment, as an example, the combination of the outer shape of the nozzle and the shape of the injection port engaging with the nozzle may be changed for each ink different in color as illustrated in FIG. 8C. The engagement combination can be designed such that the inner wall portion of the bottle flow path including the groove is positioned on the vertically lower side.

As a result, an effect of preventing the user from injecting ink of an incorrect color and avoiding mixing of inks of different colors can also be expected. The engagement combination of the nozzle shape and the shape of the injection port is merely illustrative, and is not limited to the illustrated contents. As illustrated in FIG. 8C, the number of openings of the nozzle may be two or one.

A third exemplary embodiment is another form for defining the connection posture, and is different from the above-described exemplary embodiment in that a mark easily noticeable to the user is used to guide the connection posture.

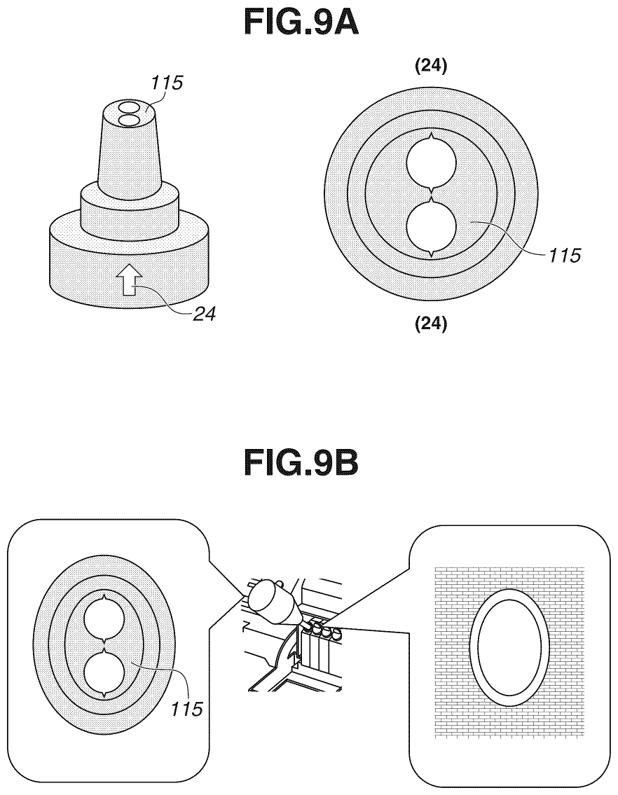

As illustrated in FIGS. 9A and 9B, in the present exemplary embodiment, convenience is improved by providing grooves in all directions corresponding not only to the vertically lower side but also to a gravity direction during injection of the ink. As illustrated in FIG. 9A, a configuration may be employed in which two marks 24 represented by, for example, arrows may be provided at opposite positions of the nozzle where the two marks 24 are easily noticeable to the user, and the grooves may be provided on the inner walls of the flow paths on an extended line connecting the two marks 24. Further, as illustrated in FIG. 9B, for example, an outer shape of the nozzle may be a line-symmetrical shape such as an elliptical shape, and the grooves may be provided on the inner walls of the flow paths on a symmetrical axis to define the connection posture.

In these cases, even when the ink is injected from any of the flow paths, the inner wall portion provided with the groove is positioned on the vertically lower side, and force that draws the ink into the bottle can be obtained. Therefore, the user no longer needs to be concerned about connection of the bottle in a specific one direction, which improves convenience compared with the first and second exemplary embodiments.

A fourth exemplary embodiment is another form for holding, by the capillary action, the liquid on the inner peripheral surface of the liquid flow path at the tip part of the nozzle main body 22, and is different from the above-described first exemplary embodiment in the number of grooves provided on the inner peripheral surface.

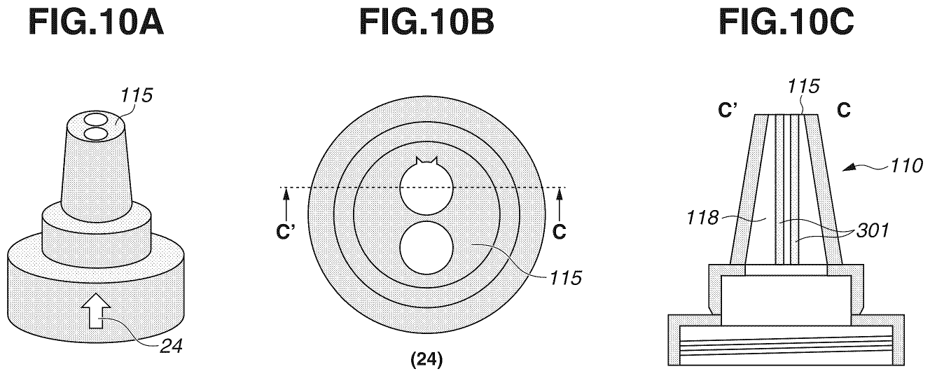

In the present exemplary embodiment, as illustrated in FIGS. 10A to 10C, a plurality of grooves 301 is provided in one flow path, which makes it possible to more effectively increase the force that draws the ink into the bottle. FIG. 10A is a perspective view of the nozzle main body 22 suitable for an exemplary embodiment of the present disclosure. FIG. 10B is a top view of the nozzle main body 22. FIG. 10C is a cross-sectional view taken along line C-C′ in FIG. 10B. In the present exemplary embodiment, two grooves 301 each having a fixed width are provided on the inner peripheral surface of one flow path, and the grooves 301 are parts of the opening of the nozzle tip part.

As in the first exemplary embodiment, a mark for defining the connection posture such as the mark 24 is provided on the nozzle main body 22. Thus, the flow path provided with the grooves is guided to be positioned on the vertically lower side when the user injects the ink into the liquid tank of the recording apparatus. In such a connection posture, the inner wall portion provided with the two grooves is positioned on the vertically lower side, and as compared with a case where only one groove is provided, force that draws the ink into the bottle is increased, which is more desirable.

A fifth exemplary embodiment is another form for holding, by the capillary action, the liquid on the inner peripheral surface of the liquid flow path at the tip part of the nozzle main body 22, and is different from the above-described fourth exemplary embodiment in that the grooves provided on the inner peripheral surface are branched or merged.

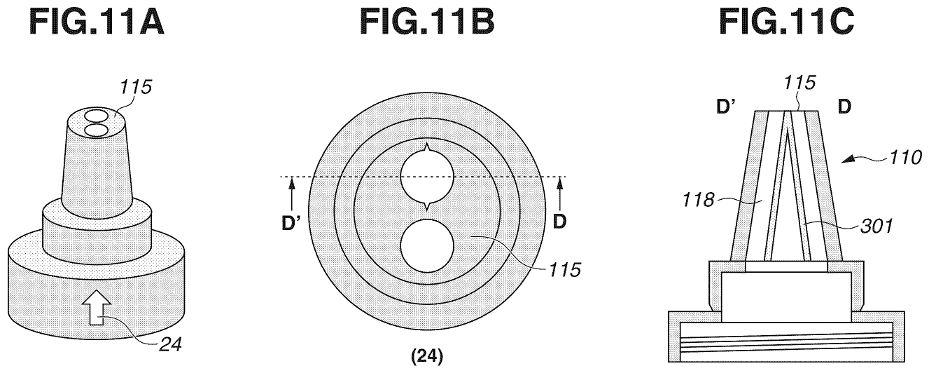

In the present exemplary embodiment, as illustrated in FIGS. 11A to 11C, a plurality of grooves 301 is provided in one flow path, and the grooves 301 are branched or merged on an inner wall 116 of the flow path, which makes it possible to more effectively increase the force that draws the ink into the bottle. FIG. 11A is a perspective view of the nozzle main body 22 suitable for an exemplary embodiment of the present disclosure. FIG. 11B is a top view of the nozzle main body 22. FIG. 11C is a cross-sectional view taken along line D-D′in FIG. 11B. In the present exemplary embodiment, two grooves 301 each having a fixed width are provided on the inner peripheral surface of one flow path, and the grooves 301 merge into one groove partway on the inner wall 116 of the flow path, and the one groove is a part of the opening at the nozzle tip part.

As in the first exemplary embodiment, a mark for defining the connection posture such as the mark 24 is provided on the nozzle main body 22. Thus, the flow path provided with the grooves is guided to be positioned on a vertically lower side when the user injects the ink into the liquid tank of the recording apparatus. In such a connection posture, the inner wall portion provided with the two grooves is positioned on the vertically lower side, and as compared with the case where only one groove is provided, force that draws the ink into the bottle is increased. In addition, even in a case where the nozzle tip part is thin, the capillary action of the grooves 301 can be efficiently increased.

A sixth exemplary embodiment is another form for holding, by the capillary action, the liquid on the inner peripheral surface of the liquid flow path at the tip part of the nozzle main body 22, and is different from the above-described fifth exemplary embodiment in a position and direction where the grooves provided on the inner peripheral surface are branched or merged.

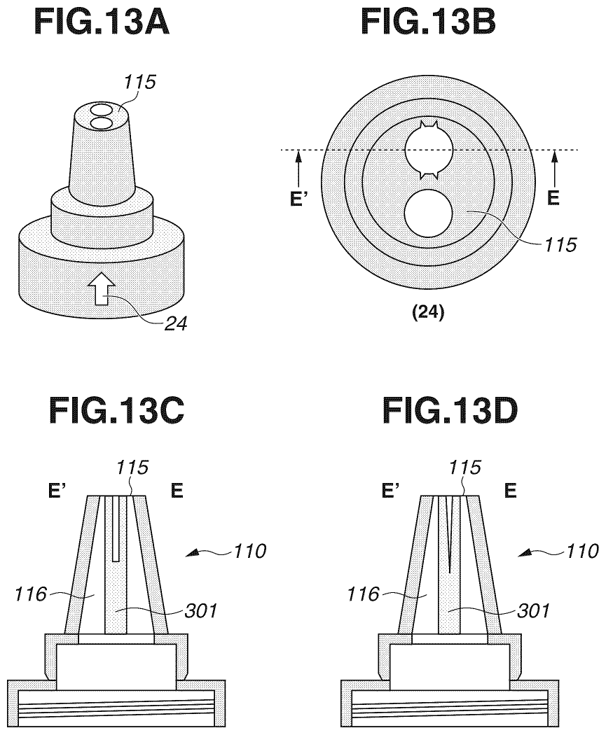

In the present exemplary embodiment, as illustrated in FIGS. 13A to 13C, a plurality of grooves 301 is provided in one flow path as in the fifth exemplary embodiment, and the grooves 301 are branched or merged on the inner wall 116 of the flow path, which makes it possible to increase the force that draws the ink into the bottle. Further, an effect of improving formability of the nozzle main body 22 and the grooves 301 can be expected. FIG. 13A is a perspective view of the nozzle main body 22 suitable for an exemplary embodiment of the present disclosure. FIG. 13B is a top view of the nozzle main body 22. FIGS. 13C and 13D are cross-sectional views taken along line E-E′ in FIG. 13B. In the present exemplary embodiment, at the nozzle tip part, two groves 301 are provided on the inner peripheral surface of one flow path and are parts of the opening. However, these grooves 301 merge into one groove partway on the inner wall 116 of the flow path, and the one groove is provided at the nozzle base end part.

As in the first exemplary embodiment, a mark for defining the connection posture such as the mark 24 is provided on the nozzle main body 22. Thus, the flow path provided with the grooves is guided to be positioned on the vertically lower side when the user injects the ink into the liquid tank of the recording apparatus. In such a connection posture, the inner wall portion provided with the two grooves is positioned on the vertically lower side, and as compared with the case where only one groove is provided, force that draws the ink into the bottle is increased. In addition, the force that draws the ink is further increased because the grooves are merged on the nozzle base end side and increased in width. Furthermore, an effect of improving formability of the nozzle main body 22 and the grooves 301 can be expected in a method using die-cutting.

A seventh exemplary embodiment is another form for holding, by the capillary action, the liquid on the inner peripheral surface of the liquid flow path at the tip part of the nozzle main body 22, and is different from the above-described first exemplary embodiment in that not a groove but a rib is provided on the inner peripheral surface.

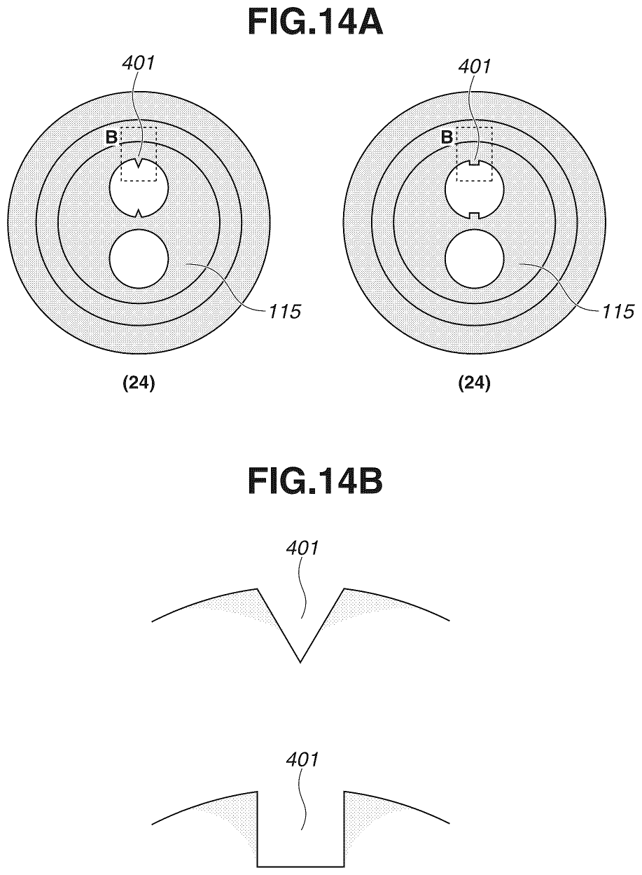

In the present exemplary embodiment, as illustrated in FIGS. 14A and 14B, a plurality of ribs 401 each having a fixed width is provided on the inner peripheral surface of one flow path, and the ribs 401 are parts of the opening at the nozzle tip part. FIG. 14A is a top view of the nozzle main body 22. The capillary action is generated by providing a protruded structure and forming a ridge line with side walls and the protruded structure. FIG. 14B is an enlarged cross-sectional view of one of the ribs 401 of the nozzle, and illustrates a state where the ink is held at a portion between the side walls and the ridge line of the rib 401 to form meniscus. Only one rib or a plurality of ribs may be provided in one flow path.

As in the first exemplary embodiment, a mark for defining the connection posture such as the mark 24 is provided on the nozzle main body 22. Thus, the flow path provided with the ribs 401 is guided to be positioned on the vertically lower side when the user injects the ink into the liquid tank of the recording apparatus. The above-described exemplary embodiments may be combined freely as long as no conflicts arise.

According to the exemplary embodiments of the present disclosure, after the ink is supplied to the liquid tank, dripping of the ink from the periphery of the opening of the liquid storage bottle and dropping of the ink to the side surface of the liquid storage bottle can be reduced.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-069695, filed Apr. 23, 2024, which is hereby incorporated by reference herein in its entirety.

What is claimed is:

1. A liquid storage bottle for replenishing liquid to a recording apparatus including a liquid tank, the liquid tank including a storage portion configured to store the liquid to be supplied to a recording head configured to eject the ink, and a liquid injection portion configured to receive supply of the liquid, the liquid storage bottle comprising:
a bottle main body configured to store the liquid; and
a liquid supply portion including a base end part having an opening communicating with the bottle main body and a tip part having an opening communicating with the liquid tank, and including a liquid flow path for supplying the liquid from the bottle main body to the liquid tank,
wherein a holding portion configured to hold the liquid by capillary action is provided on an inner peripheral surface of the opening at the tip part.

2. The liquid storage bottle according to claim 1, wherein the holding portion is a groove provided on the inner peripheral surface, and the groove is a part of the opening at the tip part.

3. The liquid storage bottle according to claim 2, wherein the groove includes at least one corner part.

4. The liquid storage bottle according to claim 3, wherein a plurality of grooves is provided.

5. The liquid storage bottle according to claim 3, wherein the groove is branched on an inner peripheral surface of the liquid flow path.

6. The liquid storage bottle according to claim 1, wherein the holding portion is a rib provided on the inner peripheral surface, and the rib is a part of the opening at the tip part.

7. The liquid storage bottle according to claim 1, wherein an outer peripheral surface of the liquid supply portion is configured to be engageable with an inner peripheral surface of the liquid injection portion.

8. A liquid replenishment system, comprising:
a liquid storage bottle for replenishing liquid to a recording apparatus including a liquid tank, the liquid tank including a storage portion configured to store the liquid to be supplied to a recording head configured to eject the ink, and a liquid injection portion configured to receive supply of the liquid, the liquid storage bottle comprising:
a bottle main body configured to store the liquid; and
a liquid supply portion including a base end part having an opening communicating with the bottle main body and a tip part having an opening communicating with the liquid tank, and including a liquid flow path for supplying the liquid from the bottle main body to the liquid tank;
the recording head configured to perform recording by ejecting the liquid; and
the liquid tank,
wherein a holding portion configured to hold the liquid by capillary action is provided on an inner peripheral surface of the opening at the tip part.

9. The liquid replenishment system according to claim 8,
wherein the liquid tank includes an inclined surface inclined relative to a horizontal direction and a vertical direction when in use, and
wherein the liquid injection portion into which the liquid supply portion of the liquid storage bottle is inserted is formed on the inclined surface.
